(19) United States
(12) Patent Application Publication
(10) Pub. No.: US 2009/0190326 A1
(43) Pub. Date: Jul. 30, 2009

(54) LED ILLUMINATION APPARATUS

(75) Inventor: SHUSAKU KON, Tokyo (JP)

Correspondence Address: YOUNG & THOMPSON, 209 Madison Street, Suite 500, ALEXANDRIA, VA, 22314, US

(73) Assignee: NEC LIGHTING, LTD., Tokyo (JP)

(21) Appl. No.: 12/352,061

(22) Filed: Jan. 12, 2009

(30) Foreign Application Priority Data
Jan. 28, 2008 (JP) 2008-016356

(51) Int. Cl. F21V 33/00

(52) U.S. Cl. 362/84

(57) ABSTRACT

The present invention aims to realize a technique to make precise chromaticity changes over a wide range in an LED illumination apparatus based on a white LED light, and comprises a first LED; a package for accommodating said first LED; a transparent medium for filling said package, said transparent medium containing a fluorophore which generates a white light when said first LED emits light; and a plurality of LEDs, wherein said first LED and the plurality of LEDs respectively have different dominant wavelengths.

This application is based upon and claims the benefit of priority from Japanese patent application No. 2008-016356, filed on Jan. 28, 2008, the disclosure of which is incorporated herein in its entirety by reference.

### BACKGROUND OF THE INVENTION

1. Field of the Invention

The present invention relates to an illumination apparatus utilizing an LED (Light Emitting Diode).

2. Description of the Related Art

An illumination apparatus utilizing an LED is disclosed in Japanese Patent Laid-Open No. 2004-80046.

Japanese Patent Laid-Open No. 2004-80046 describes that when a white light emission is obtained by combining a red, green, and blue LED element, color irregularities are likely to occur and when a white light emission is obtained by combining a blue LED element and a yellow fluorescent substance, poor reproducibility of red color results; and discloses a technique to achieve an LED illumination apparatus having a good color rendering property by supplementing a red color component, which lacks a white LED, through combining white and red LEDs.

Currently, fluorescent lights are used for the illumination of showcases and the like. When an object to be illuminated is known, the requirement is for a particular illumination that enables a desired color to stand out. For example, in the case of a showcase for meat products, illumination by a light source having a red-rich spectrum will make the meat products look fresher, and in the case of a showcase for vegetables, an illumination by a light source having a green-rich spectrum will make the vegetables look fresher. However, it is often the case that the desired light color subtly varies depending on the difference in the interior illumination of stores and people's tastes.

Currently, the sale and developments of LED illumination apparatuses for showcases is conducted in such a way that fluorescent light samples are brought to the customer's premises and the samples are made to emit light on-site to observe the customer's response.

Such method may require a significant amount of time and cost because, if the light emission characteristics of the sample that has been brought to the customer do not satisfy the customer's need, it is necessary to create samples having new light emission characteristics and to bring them to the customer again.

In the technique disclosed by Japanese Patent Laid-Open No. 2004-80046, a red color component which lacks a white LED is supplemented by combining a white LED and a red LED; however, precise control of the light color over a wider range will be difficult since the intensity is to be controlled by a single red LED.

When illuminating a particular object, such as object displayed in a showcase, what is desired is that a particular color be made to stand out in order to enhance the appearance of the particular object. In order to achieve that, it is necessary to make precise chromaticity changes over a wide range in a particular region.

### SUMMARY OF THE INVENTION

The present invention aims to realize a technique to make precise chromaticity changes over a wide range in an LED illumination apparatus based on a white LED light

The LED illumination apparatus according to the present invention comprises:

a first LED;

a package for accommodating said first LED;

a transparent medium for filling said package, said transparent medium containing a fluorophore which generates a white light when said first LED emits light; and

a plurality of LEDs, wherein

said first LED and the plurality of LEDs respectively have different dominant wavelengths.

The LED illumination apparatus according to another aspect of the present invention comprises:

a first LED;

a package for accommodating said first LED;

a transparent medium for filling said package;

another transparent medium for covering said transparent medium, said another transparent medium containing a fluorophore which generates a white light when said first LED emits light; and

a plurality of LEDs, wherein

said first LED and the plurality of LEDs respectively have different dominant wavelengths.

### BRIEF DESCRIPTION OF THE DRAWINGS

FIG. 1 is a sectional view to show the configuration of an exemplary embodiment of the LED illumination apparatus according to the present invention;

FIG. 2 is a top view to show the layout condition of each LED of the exemplary embodiment shown in FIG. 1;

FIG. 3 shows a spectral distribution of the LED illumination apparatus when each LED of the exemplary embodiment shown in FIG. 1 is caused to emit light individually;

FIG. 4 shows a light emitting state of each LED of the exemplary embodiment shown in FIG. 1;

FIG. 5 shows the spectral distribution of the LED illumination apparatus in the light emitting state shown in FIG. 4;

FIG. 6 shows a light emitting state of each LED of the exemplary embodiment shown in FIG. 1;

FIG. 7 shows the spectral distribution of the LED illumination apparatus in the light emitting state shown in FIG. 6;

FIG. 8 shows a light emitting state of each LED of the exemplary embodiment shown in FIG. 1;

FIG. 9 shows the spectral distribution of the LED illumination apparatus in the light emitting state shown in FIG. 8;

FIG. 10 is a sectional view to show the configuration of a second exemplary embodiment of the LED illumination apparatus according to the present invention;

FIG. 11 is a top view to show the layout condition of each LED of the exemplary embodiment shown in FIG. 10;

FIG. 12 shows a spectral distribution of the LED illumination apparatus when each LED of the exemplary embodiment shown in FIG. 1 0 is caused to emit light individually;

FIG. 13 shows a light emitting state of each LED of the exemplary embodiment shown in FIG. 10;

FIG. 14 shows the spectral distribution of the LED illumination apparatus in the light emitting state shown in FIG. 13;

FIG. 15 shows a light emitting state of each LED of the exemplary embodiment shown in FIG. 10;

FIG. 16 shows the spectral distribution of the LED illumination apparatus in the light emitting state shown in FIG. 15;

FIG. 17 shows a light emitting state of each LED of the exemplary embodiment shown in FIG. 10;

FIG. 18 shows the spectral distribution of the LED illumination apparatus in the light emitting state shown in FIG. 17; and

FIG. 19 is a sectional view to show the configuration of another exemplary embodiment of the LED illumination apparatus according to the present invention.

### EXEMPLARY EMBODIMENT

Next, exemplary embodiments will be described with reference to the drawings.

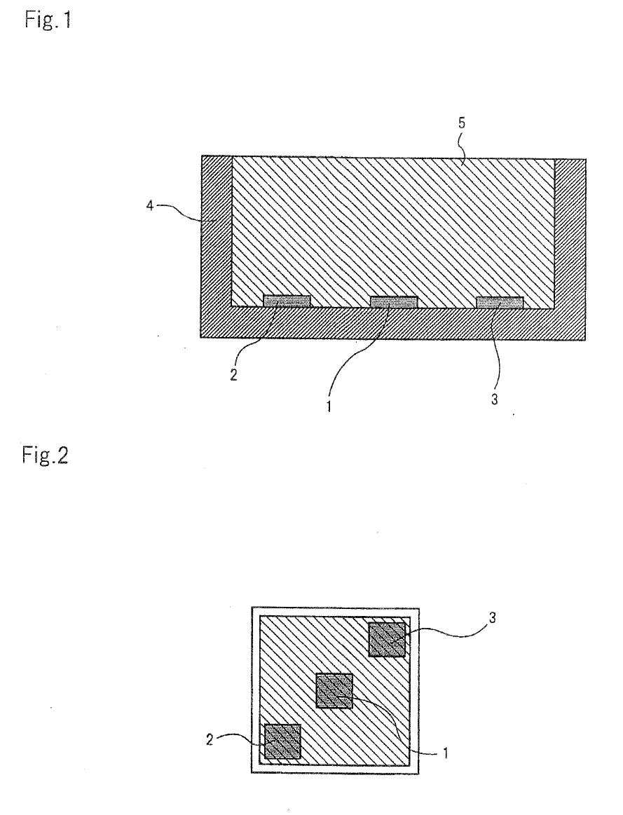

FIG. 1 is a sectional view showing the configuration of an exemplary embodiment of the LED illumination apparatus according to the present invention.

There are disposed blue LED 1, red LED 2, and red LED 3 in the bottom face of package 4 made of plastics ceramics, and the like, and fluorophore-containing transparent medium 5 into which a fluorophore is mixed is packed on top of the each LED.

FIG. 2 is a top view showing the layout condition of each LED, in which red LED 2 and red LED 3 are disposed in symmetry with respect to blue LED 1 interposed therebetween.

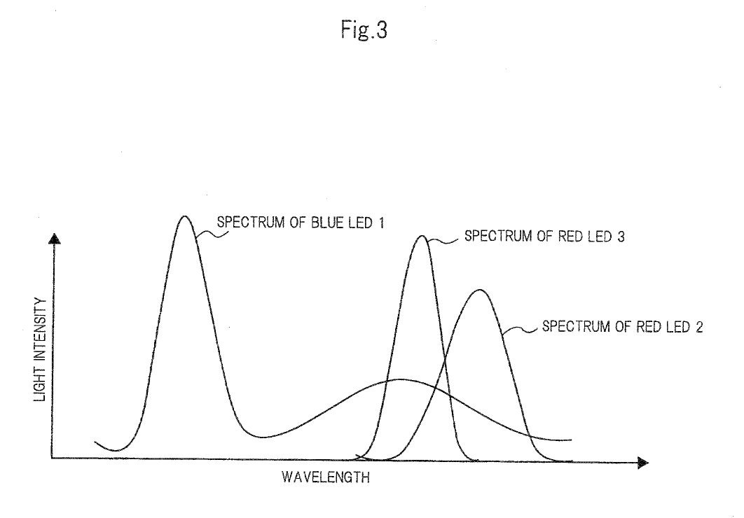

FIG. 3 shows a spectral distribution of the LED illumination apparatus when each LED is caused to emit light individually.

10 As shown in FIG. 3, each LED has a different dominant wavelength. Further, a fluorescent light is generated through a light emission of blue LED 1 and also a green light and a red light are generated when blue LED 1 emits light so that a white color is observed as a whole. It is noted that the blue LED may be an LED which generates an ultraviolet light.

The LED illumination apparatus of the present exemplary embodiment, in which the main illumination source is blue LED 1, uses an LED which has the largest output power among the LEDs as blue LED 1, and which exploits the light emission of red LED 2 and red LED 3 to control the light color. A drive circuit (not shown) for each LED is separated respectively and is configured such that each light emission can be controlled individually. Blue LED 1 and red LEDs 2 and 3 may be packaged separately.

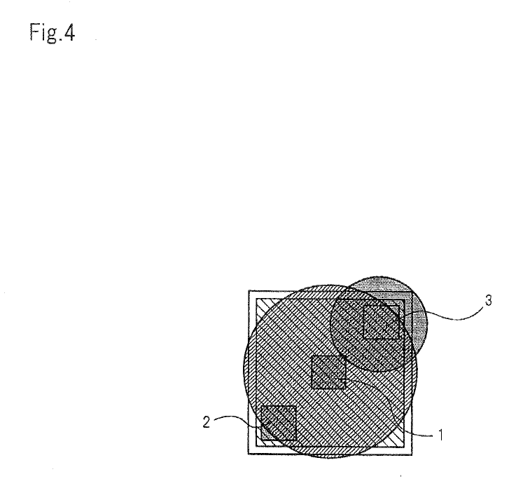

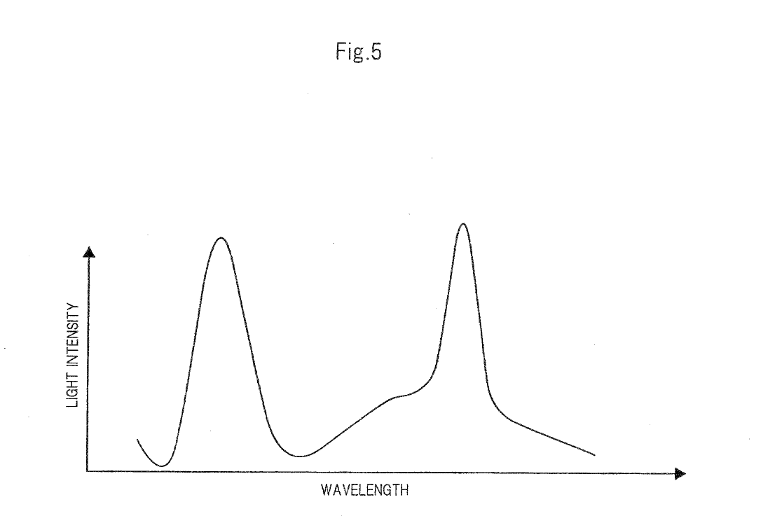

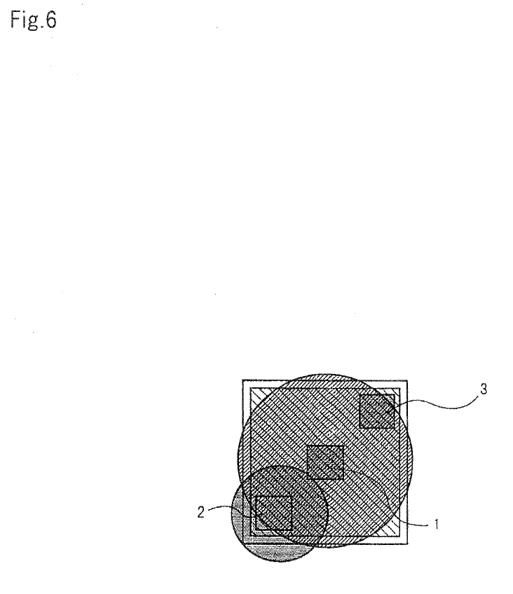

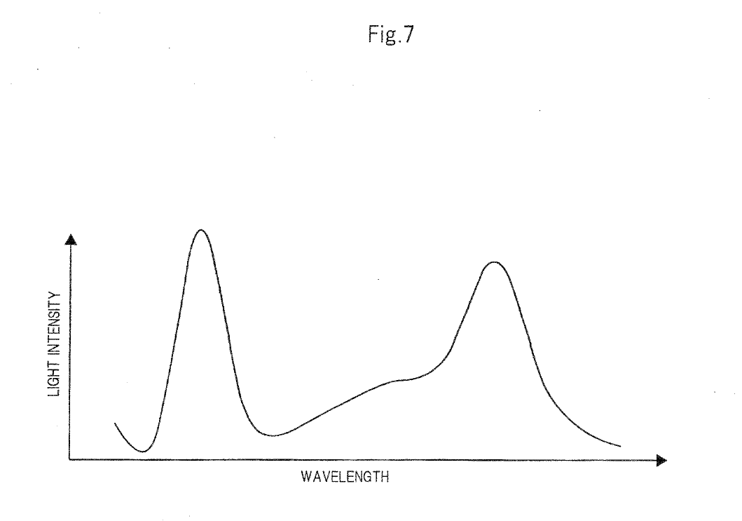

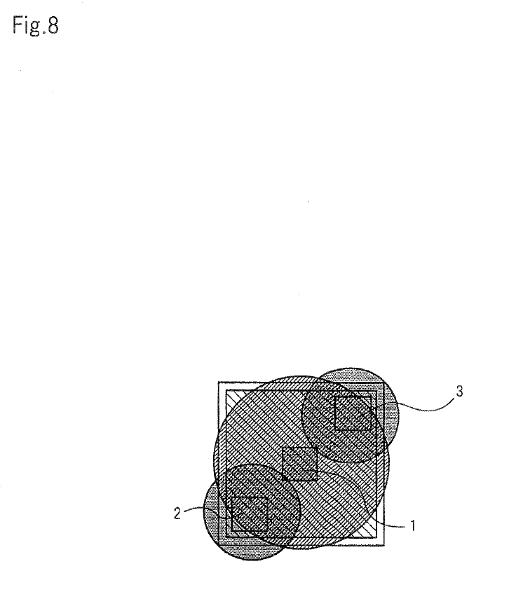

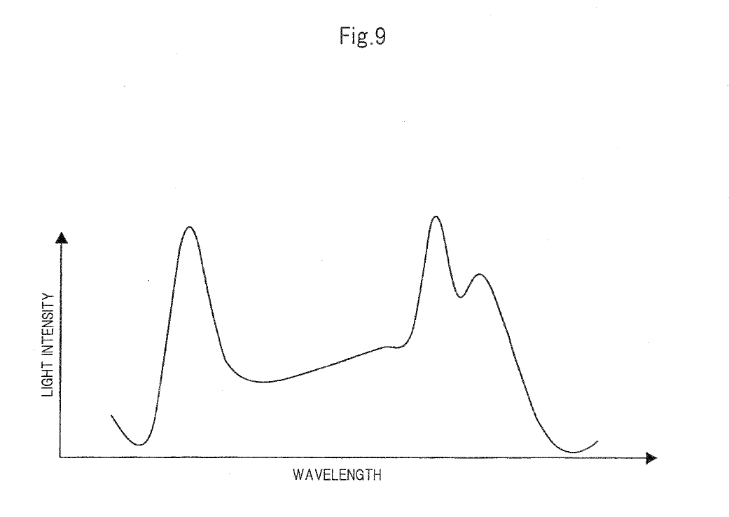

When blue LED 1 and red LED 3 are caused to emit light as shown in FIG. 4, the spectral distribution shown in FIG. 5 will result. When blue LED 1 and red LED 2 are caused to emit light as shown in FIG. 6, the spectral distribution shown in FIG. 7 will result. When blue LED 1 and red LEDs 2 and 3 are caused to emit light as shown in FIG. 8, the spectral distribution shown in FIG. 9 will result.

Next, a second exemplary embodiment will be described with reference to the drawings.

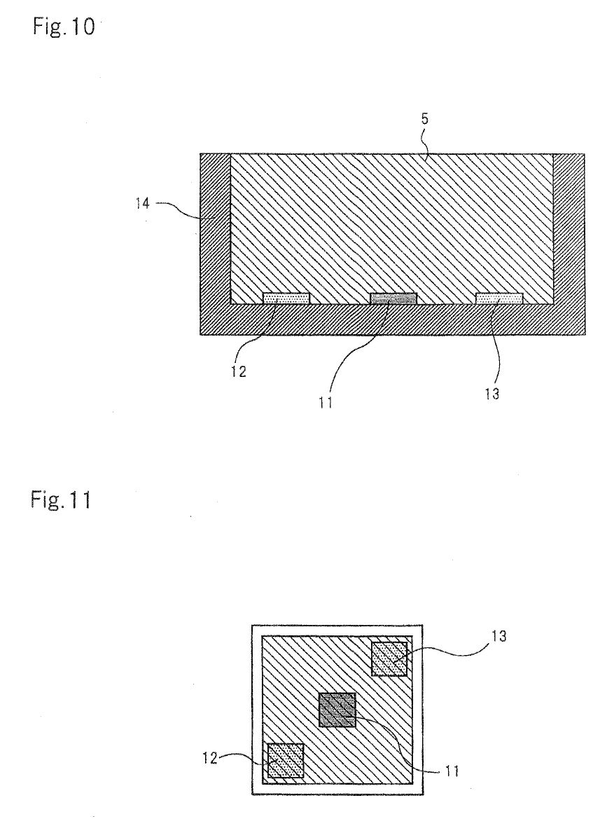

FIG. 10 is a sectional view showing the configuration of a second exemplary embodiment of the LED illumination apparatus according to the present invention.

There are disposed blue LED 11, green LED 12, and green LED 13 in the bottom face of package 14 made of plastics, ceramics, and the like, and fluorophore-containing transparent medium 15 into which a fluorophore is mixed is packed on top of the each LED.

FIG. 11 is a top view showing the layout condition of each LED in which green LED 12 and green LED 13 are disposed in symmetry with respect to blue LED 11 interposed therebetween.

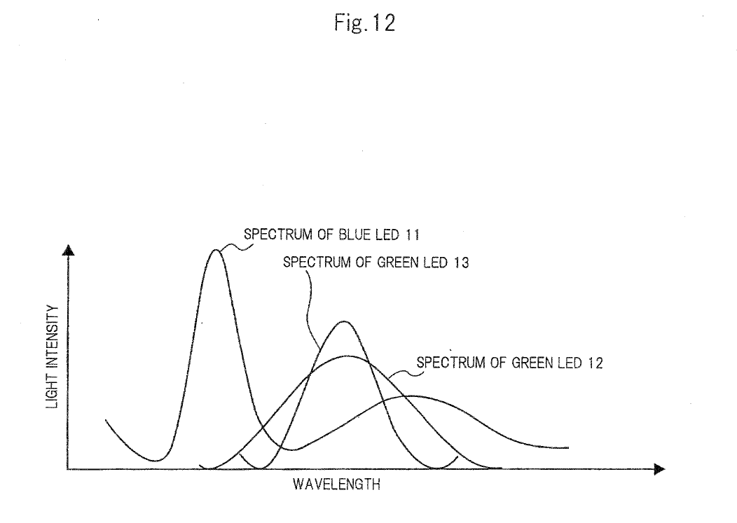

FIG. 12 shows the spectral distribution of the LED illumination apparatus when each LED is caused to emit light individually.

As shown in FIG. 12, each LED is configured to have a different dominant wavelength. Further, a fluorescent light is generated through the light emission of blue LED 11 and also a green light and a red light are generated when blue LED 11 emits light so that a white color is observed as pure white. It is noted that the blue LED may be an LED which generates an ultraviolet light.

The LED illumination apparatus of the present exemplary embodiment, in which the main illumination source is blue LED 11, uses an LED which has the largest output power among the LEDs as blue LED 11, and which exploits the light emission of green LED 12 and green LED 13 to control the light color, A drive circuit (not shown) for each LED is separated respectively and is configured such that each light emission can be controlled individually. Blue LED 11 and green LEDs 12 and 13 may be packaged separately.

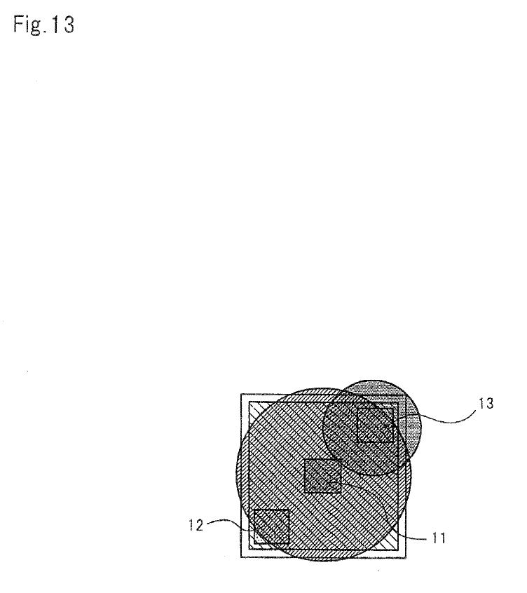

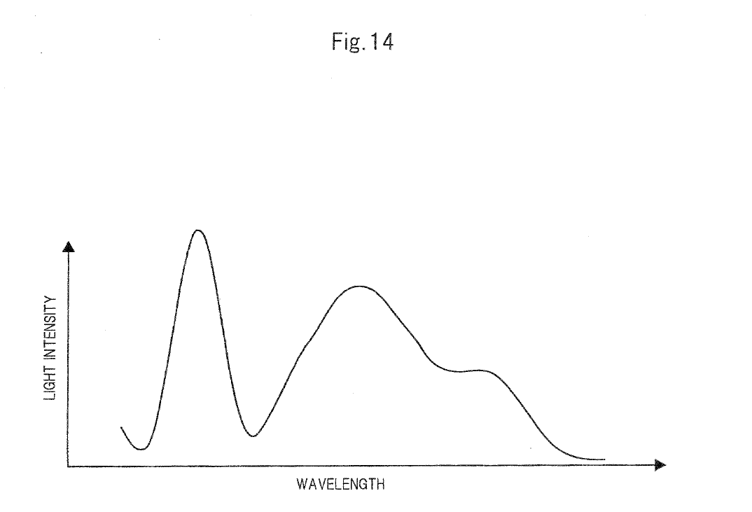

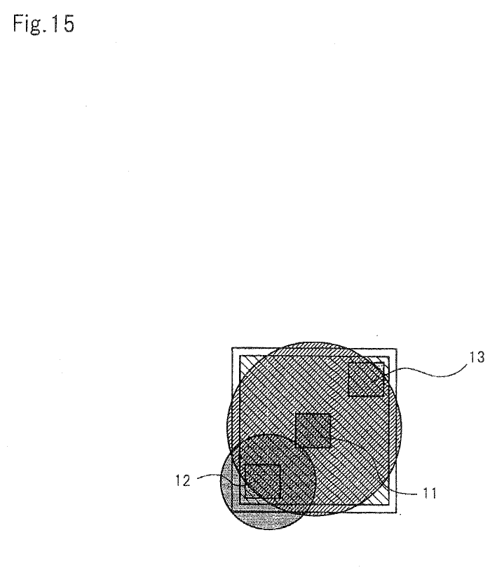

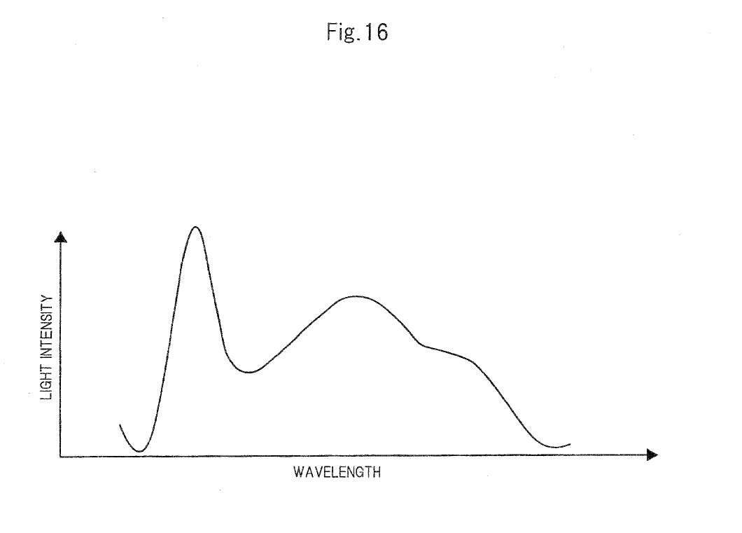

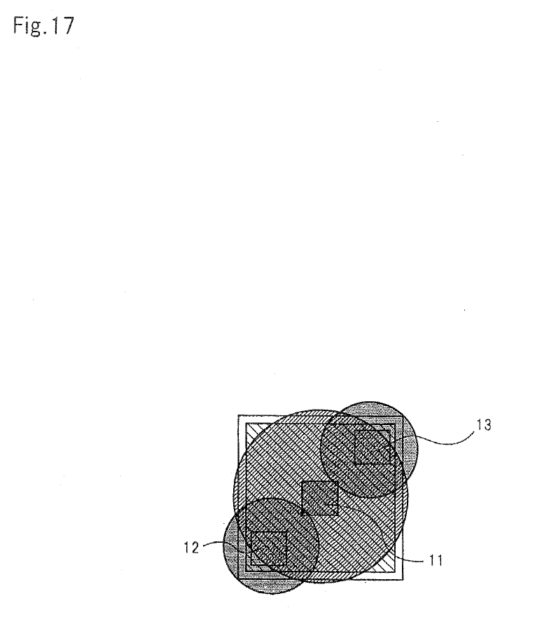

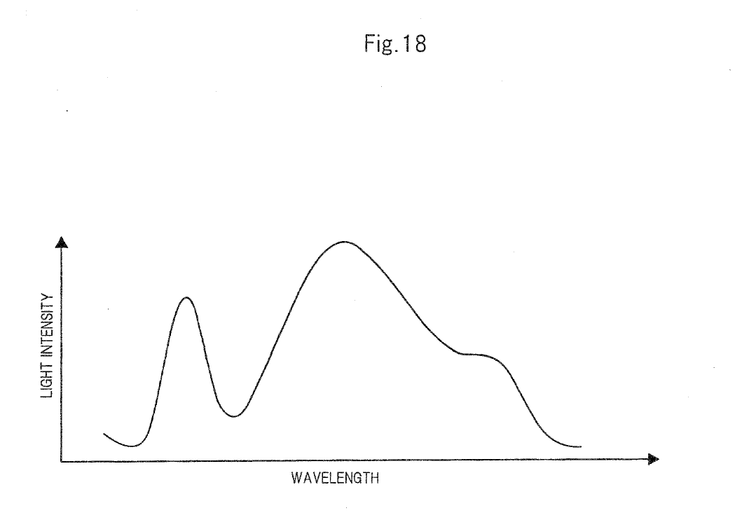

When blue LED 11 and green LED 13 are caused to emit light as shown in FIG. 13, the spectral distribution shown in FIG. 14 will result. When blue LED 11 and green LED 12 are caused to emit light as shown in FIG. 15, the spectral distribution shown in FIG. 1 6 will result. When blue LED 11 and green LEDs 12 and 13 are caused to emit light as shown in FIG. 17, the spectral distribution shown in FIG. 18 will result.

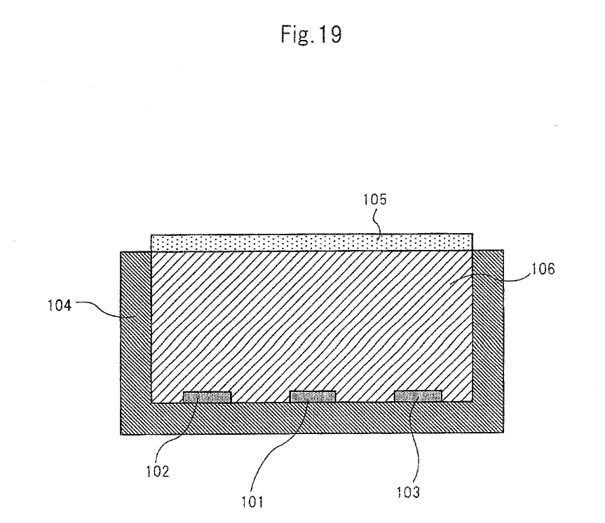

It is noted that although the exemplary embodiments have a structure in which the entire package is sealed with a transparent medium into which a fluorophore is mixed, a structure in which an LED sealing part and a fluorophore containing part are separated as shown in FIG. 19 may be used.

In an exemplary embodiment shown in FIG. 19, there are disposed blue LED 101, red LED 102, and red LED 103 in the bottom face of package 104 made of plastics, ceramics, and the like; transparent medium 106 is packed on top of the each LED; and fluorophore-containing transparent medium 105, into which a fluorophore is mixed, is placed in such a way as to cover transparent medium 106.

Further, when an ultraviolet LED is used as the excitation light, mounting a plurality of blue LEDs each of which has a different dominant wavelength will make it possible to perform precise chromaticity control even in a blue region and therefore such a configuration may also be adopted.

In the present invention configured as described above, a white light is obtained by a first LED and a fluorophore-containing transparent medium, and further a plurality of LEDs, each of which has a different dominant wavelength, are provided. By differentiating the ON state of each of the LEDs, it becomes possible to obtain lights with various spectral distributions and to change the light color of one LED illumination apparatus over a wide range by making precise chromaticity changes. Since such an LED illumination apparatus has a higher potential for realizing a light emitting characteristic which meets the customer's need, it becomes possible to let customers choose their favorite colors and to perform illumination design based on the data thus leading to a reduction in time and cost.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the is claims.

What is claimed is:

1 An LED illumination apparatus, comprising:
a first LED;
a package for accommodating said first LED;
a transparent medium for filling said package, said transparent medium containing a fluorophore which generates a white light when said first LED emits light; and
a plurality of LEDs, wherein
said first LED and the plurality of LEDs respectively have different dominant wavelengths.

2. An LED illumination apparatus, comprising:
a first LED;
a package for accommodating said first LED;
a transparent medium for filling said package;
another transparent medium for covering said transparent medium, said another transparent medium containing a fluorophore which generates a white light when said first LED emits light; and
a plurality of LEDs, wherein
said first LED and the plurality of LEDs respectively have different dominant wavelengths.

3. The LED illumination apparatus according to claim 1, wherein
said plurality of LEDs are accommodated in said package with said first LED.

4. The LED illumination apparatus according to claim 2, wherein
said plurality of LEDs are accommodated in said package with said first LED.

5. The LED illumination apparatus according to claim 1, wherein
said first LED generates a blue light.

6. The LED illumination apparatus according to claim 2, wherein
said first LED generates a blue light.

7. The LED illumination apparatus according to claim 3, wherein
said first LED generates a blue light.

8. The LED illumination apparatus according to claim 1, wherein
said first LED generates an ultraviolet light.

9. The LED illumination apparatus according to claim 2, wherein
said first LED generates an ultraviolet light.
